(19) United States
(12) Patent Application Publication
(10) Pub. No.: US 2009/0125846 A1
(43) Pub. Date: May 14, 2009

(54) Facility to Show Secondary Relationships in a Topological Graph Using an Associated View

(76) Inventors: Mark A. Anderson, Cary, NC (US); Cerelisa C. Burr, Cary, NC (US); Scott M. Dominick, Cary, NC (US); Scott B. Greer, Cary, NC (US); Niraj P. Joshi, Cary, NC (US); Richard B. Southard, Clayton, NC (US)

Correspondence Address: DILLON & YUDELL LLP, 8911 N. CAPITAL OF TEXAS HWY., SUITE 2110, AUSTIN, TX, 78759, US

(21) Appl. No.: 11/936,931

(22) Filed: Nov. 8, 2007

(51) Int. Cl. G06F 3/048

(52) U.S. Cl. 715/853

(57) ABSTRACT

A method, system, and computer program product for identifying the relationships between managed resources and displaying these relationships and resources in an interactive computerized system. A Relationships Display and Highlight (RDH) utility provides both an interactive view of a primary relationship via a topological graph and an interactive associated view to highlight the secondary relationships between a set of managed resources. The RDH utility links the graphical view to the associated view by displaying and/or highlighting the resources in the graphical view when secondary relationships are interactively explored in the associated view. When a secondary relationship is selected via the associated view, each resource which participates directly in the selected secondary relationship is highlighted, within the topological graph. When a resource is selected via the primary view, the RDH utility identifies a set of relationships in the associated view in which the resource participates.

### BACKGROUND

The present invention generally relates to computer systems and in particular to a facility for displaying relationships within a computer system. Modern monitoring and control software applications, such as those used for systems management, often use a graphical topology to display the monitored state of managed resources. The content and layout of these topological graphs display a key relationship between the displayed resources. This relationship often represents containment, membership, or a certain type of collaboration between the resources. It is not uncommon, however, for the resources in the graph to have other interesting secondary relationships. Existing solutions have approached visualizing these other relationships by changing the current display of the data (e.g., rearranging the nodes and links on the topological graph, adding additional links and labels, or changing the visualization to another representation such as a tree structure).

By changing the display of the data, the secondary relationship is (visually) presented at the expense of the user having to grasp the change in the visualization of the data. These changes can be disorienting depending on the extent of the change, especially in large or complex graphs. Some existing solutions attempt to minimize the potential cluttering of the graph by allowing the user to filter out a part of the graph from the visualization based on various criteria, including the filtering out of secondary relationships. The problem with this solution is that it is difficult to remember the relationships to the data that were filtered out.

### SUMMARY OF ILLUSTRATIVE EMBODIMENTS

Disclosed are a method, system, and computer program product for identifying the relationships between managed resources and displaying these relationships and resources in an interactive computerized system. A Relationships Display and Highlight (RDH) utility provides both an interactive view of a primary relationship via a topological graph and an interactive associated view to highlight the secondary relationships between a set of managed resources. The RDH utility links the graphical view to the associated view by displaying and/or highlighting the resources in the graphical view when secondary relationships are interactively explored in the associated view. When a secondary relationship is selected via the associated view, each resource which participates directly in the selected secondary relationship is highlighted, within the topological graph. When a resource is selected via the primary view, the RDH utility identifies a set of relationships in the associated view in which the resource participates.

The above as well as additional features of the present invention will become apparent in the following detailed written description.

### BRIEF DESCRIPTION OF THE DRAWINGS

The invention itself will best be understood by reference to the following detailed description of an illustrative embodiment when read in conjunction with the accompanying drawings, wherein:

FIG. 1 is a block diagram representation of a data processing system, according to one embodiment of the invention;

FIG. 2 illustrates a screen display of an example topological graph, according to the prior art;

FIG. 3 illustrates a screen display of an example topological graph with a secondary view, according to one embodiment of the invention;

FIG. 4 illustrates a screen display of an example topological graph with a secondary view, according to one embodiment of the invention;

FIG. 5 illustrates a screen display of an example topological graph with a secondary view, according to one embodiment of the invention;

FIG. 6 illustrates a screen display of an example topological graph with a secondary view, according to one embodiment of the invention; and

FIG. 7 is a flow chart illustrating the process of displaying relationships between a group of resources, via a primary view and an associated view, in accordance with one embodiment of the invention.

### DETAILED DESCRIPTION OF AN ILLUSTRATIVE EMBODIMENT

The illustrative embodiments provide a method, system, and computer program product for identifying the relationships between managed resources and displaying these relationships and resources in an interactive computerized system. A Relationships Display and Highlight (RDH) utility provides both an interactive view of a primary relationship via a topological graph and an interactive associated view to highlight the secondary relationships between a set of managed resources. The RDH utility links the graphical view to the associated view by displaying and/or highlighting the resources in the graphical view when secondary relationships are interactively explored in the associated view. When a secondary relationship is selected via the associated view, each resource which participates directly in the selected secondary relationship is highlighted, within the topological graph. When a resource is selected via the primary view, the RDH utility identifies a set of relationships in the associated view in which the resource participates.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

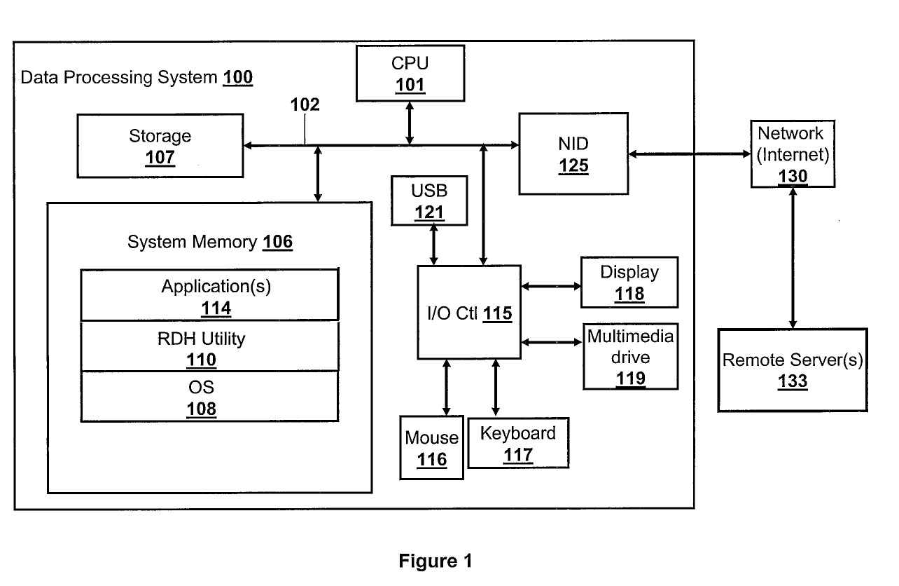

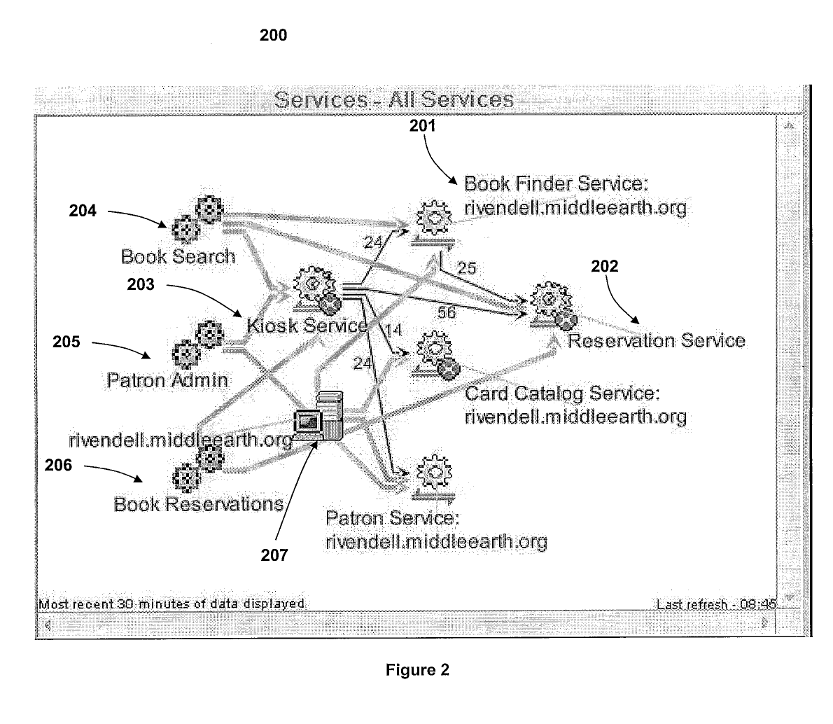

Within the descriptions of the figures, similar elements are provided similar names and reference numerals as those of the previous figure(s). Where a later figure utilizes the element in a different context or with different functionality, the element is provided a different leading numeral representative of the figure number (e.g, 1xx for FIGS. 1 and 2xx for FIG. 2). The specific numerals assigned to the elements are provided solely to aid in the description and not meant to imply any limitations (structural or functional) on the invention.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized. Specifically, as utilized herein, the term “secondary relationship” is defined as a grouping, within which, a number of resources/components/items/elements participate. Within the description of the illustrative embodiments, a resource/component may not be a secondary relationship and vice versa, i.e., a resource/component may not represent a relationship/link between a number of items/elements.

With reference now to the figures, FIG. 1 illustrates a block diagram of a data processing system (and connected network). DPS 100 comprises at least one processor or central processing unit (CPU) 101 connected to system memory 106 via system interconnect/bus 102. Also connected to system bus 102 is I/O controller 115, which provides connectivity and control for input devices, of which pointing device (or mouse) 116 and keyboard 117 are illustrated, and output devices, of which display 118 is illustrated. Additionally, a multimedia drive 119 (e.g., CDRW or DVD drive) and USB (universal serial bus) hub 121 are illustrated, coupled to I/O controller. Multimedia drive 119 and USB hub 121 may operate as both input and output (storage) mechanisms. DPS 100 also comprises storage 107, within which data/instructions/code may be stored.

DPS 100 is also illustrated with a network interface device (NID) 125, with which DPS 100 connects to one or more servers 133 via an access network, such as the Internet 130. In the described embodiments, Internet 130 is a worldwide collection of networks and gateways that utilize the Transmission Control Protocol/Internet Protocol (TCP/IP) suite of protocols to communicate with one another. Of course, network access may also be provided via a number of different types of networks, such as an intranet, a local area network (LAN), a virtual private network (VPN), or other wide area network (WAN) other than the Internet, for example.

Notably, in addition to the above described hardware components of DPS 100, various features of the invention are completed via software (or firmware) code or logic stored within memory 106 or other storage (e.g., storage 107) and executed by CPU 101. Thus, illustrated within memory 106 are a number of software/firmware components, including operating system (OS) 108 (e.g., Microsoft Windows®, a trademark of Microsoft Corp, or GNU®/Linux®, registered trademarks of the Free Software Foundation and The Linux Mark Institute), systems management software application(s) 114, and relationships display and highlight (RDH) utility 110. In actual implementation, applications 114 and RDH utility 110 may be combined as a single application collectively providing the various functions of each individual software component when the corresponding code is executed by the CPU 101. For simplicity, RDH utility 110 is illustrated and described as a stand alone or separate software/firmware component, which provides specific functions, as described below.

CPU 101 executes RDH utility 110 as well as OS 108, which supports the user interface features of RDH utility 110. In the illustrative embodiment, RDH utility 110 generates/provides several graphical user interfaces (GUI) to enable user interaction with, or manipulation of, the functional features of the utility (110) and/or APP 114. Among the software code/instructions provided by RDH utility 110, and which are specific to the invention, are: (a) code for storing data which represents relationships between managed resources; (b) code for simultaneously generating a primary view which displays an interactive topological graph and an associated view which displays an interactive relationship structure; and (c) code for displaying and/or highlighting relationships and resources/components of these relationships. For simplicity of the description, the collective body of code that enables these various features is referred to herein as RDH utility 110. According to the illustrative embodiment, when CPU 101 executes APP 114 and RDH utility 110, DPS 100 initiates a series of functional processes that enable the above functional features as well as additional features/functionality, which are described below within the description of FIGS. 2-7.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention. The data processing system depicted in FIG. 1 may be, for example, an IBM eServer pSeries system, a product of International Business Machines Corporation in Armonk, N.Y., running the Advanced Interactive Executive (AIX) operating system or LINUX operating system.

FIG. 2 is a screen display of an example topological graph, according to the prior art. Graph 200 comprises (symbolic representation for) a number of “resources” which include Book Finder Service 201, Reservation Service 202 and Kiosk Service 203. Graph 200 also comprises representation for a number of business processes which include the following secondary relationships: Book Search 204, Patron admin 205 and Book Reservations 206. Server “rivendell.middleearth.org” 207 is also illustrated within graph 200. As a secondary relationship, a business process may represent a link between a number of resources.

Topological graph 200 shows several web services (e.g., Book Finder Service 201, Reservation Service 202 and Kiosk Service 203), where the primary relationship is the number of web service message requests sent between the services during a certain time interval. Graph 200 also shows three business processes (Book Search 204, Patron admin 205 and Book Reservations 206) with arrows pointing to the web services that participate in each business process. For example, Book Finder Service 201, Reservation Service 202 and Kiosk Service 203 each participate in (business process) Book Search 204. There is also an icon for server “rivendell.middleearth.org” 207 with arrows pointing to the web services (which include Book Finder Service 201) that are deployed on that server. While all of this information is useful to a user using a systems management application that monitors the health of these web services, graph 200 may get cluttered very quickly, even with a small number of web services.

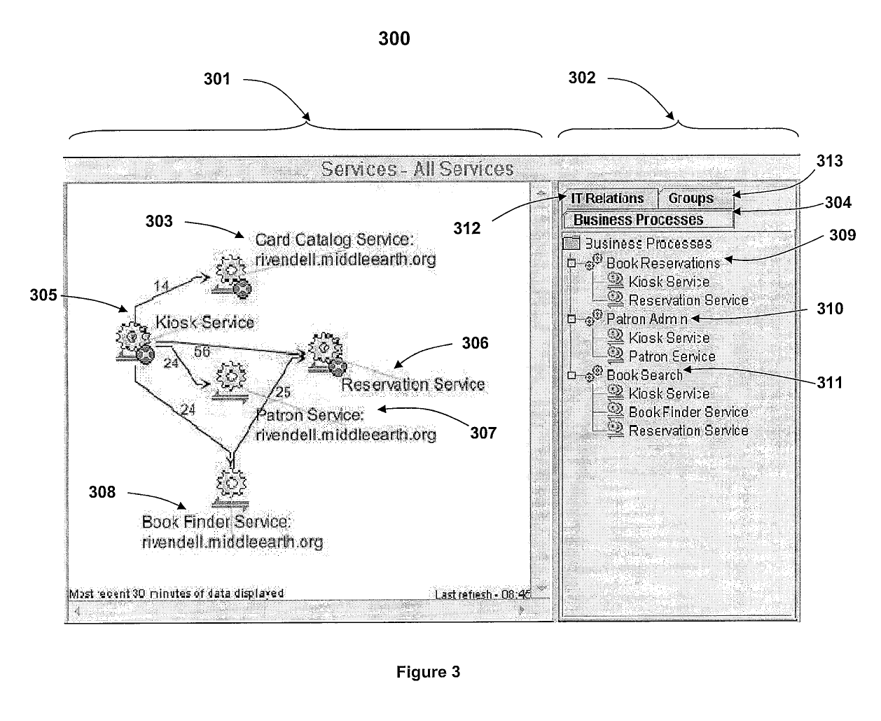

FIG. 3 is a screen display of an example topological graph with a secondary view, according to one embodiment of the invention. Display 300 comprises (primary view) graph 301, secondary view 302, and Business Processes Tab 304. Secondary view 302 includes the following business processes (which also represent several secondary relationships): Book Reservations 309, Patron Admin 310 and Book Search 311. Primary view 301 includes the following web services (i.e., the resources): Card Catalog Service 303, Kiosk Service 305, Reservation Service 306, Patron Service 307 and Book Finder Service 308.

Display 300 shows the business processes, the server, and the relationships (of servers and business processes) to the web services factored out of primary view graph 301 and into secondary view 302. The group of business processes, shown in secondary view 302, is the current relationship type that is selected via Business Processes Tab 304. Secondary view 302 to the right of graph 301 displays three distinct secondary relationships among the available web services (i.e., Card Catalog Service 303, Kiosk Service 305, Reservation Service 306, Patron Service 307 and Book Finder Service 308), the business processes (Book Reservations 309, Patron admin 310 and Book Search 311) in which the web services participate, the servers (illustrated by selecting IT relations Tab 312) on the network on which the web services are deployed, and arbitrary groupings (illustrated by selecting Groups Tab 313) of the services created by the user.

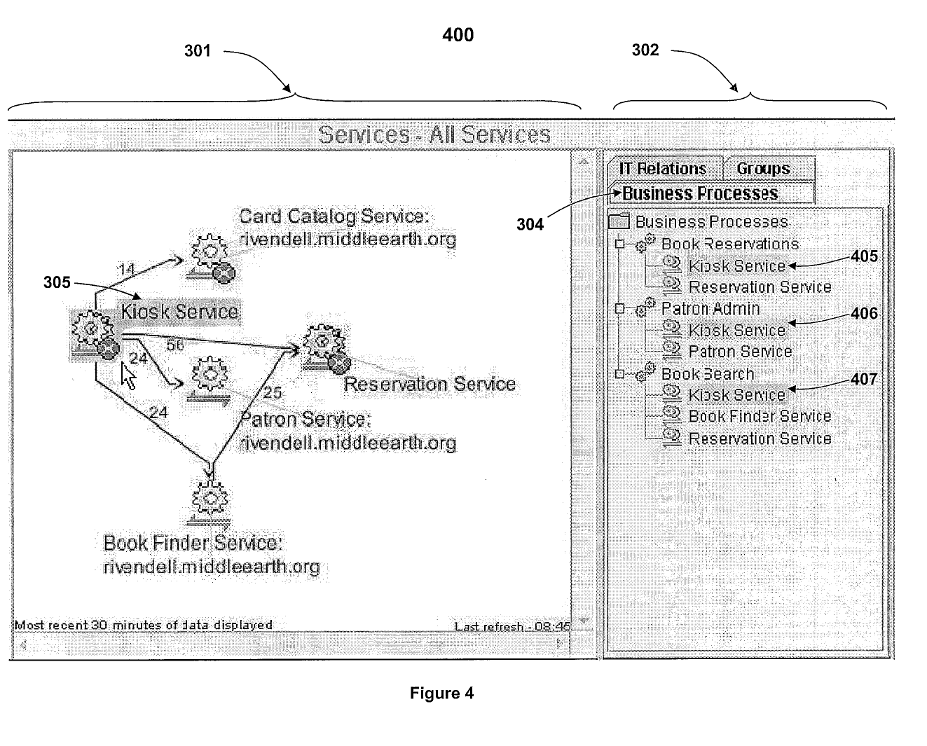

FIG. 4 is a screen display of another example topological graph with a secondary view, according to one embodiment of the invention. Display 400 comprises (primary view) graph 301, secondary view 302, and selected Business Processes Tab 304. Within display 400, Kiosk Service 305 is highlighted in graph 301. First “Kiosk Service” 405, second “Kiosk Service” 406 and third “Kiosk Service” 407 are all highlighted in secondary view 302.

Display 400 illustrates that the selection of a web service in topological graph 301 highlights the web service in secondary view 302, allowing the user to see the business processes in which the web service participates. In particular, Kiosk Service 305 is highlighted in graph 301. Consequently, all business processes in which Kiosk Service 305 participates are indicated by a common participating resource (Kiosk Service 305) represented in the associated/secondary view by first “Kiosk Service” 405, second “Kiosk Service” 406 and third “Kiosk Service” 407, respectively, which are all highlighted in secondary view 302. The secondary relationship is expressed through the tree structure displayed in secondary view 302, and the highlighting of the selected web service helps the user quickly locate the reference to the web service under the various business processes.

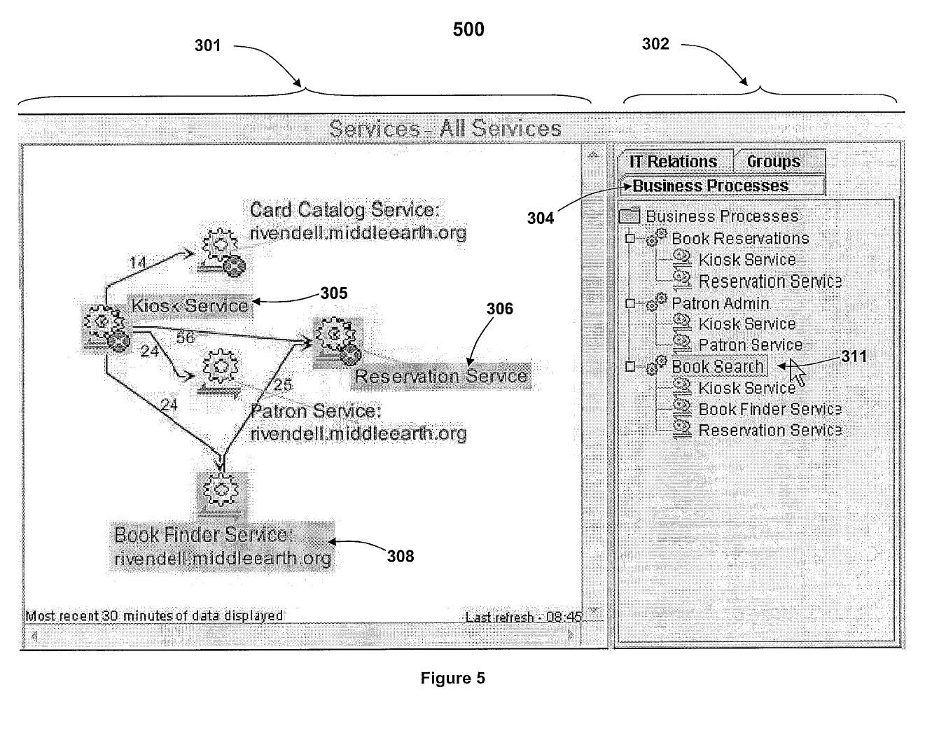

FIG. 5 is a screen display of an example topological graph with a secondary view, according to one embodiment of the invention. Display 500 comprises (primary view) graph 301, secondary view 302, and selected Business Processes Tab 304. Within display 500, Kiosk Service 305, Reservation Service 306 and Book Finder Service 308 are all highlighted in graph 301. Book Search (process) 311 is highlighted in secondary view 302.

When the user selects a business process in secondary view 302, the selection is reflected in topological graph 301 so the user sees the web services highlighted that participate in the business process. In particular, Kiosk Service 305, Reservation Service 306 and Book Finder Service 308 are all highlighted in display 500 as these services all participate in Book Search (process) 311.

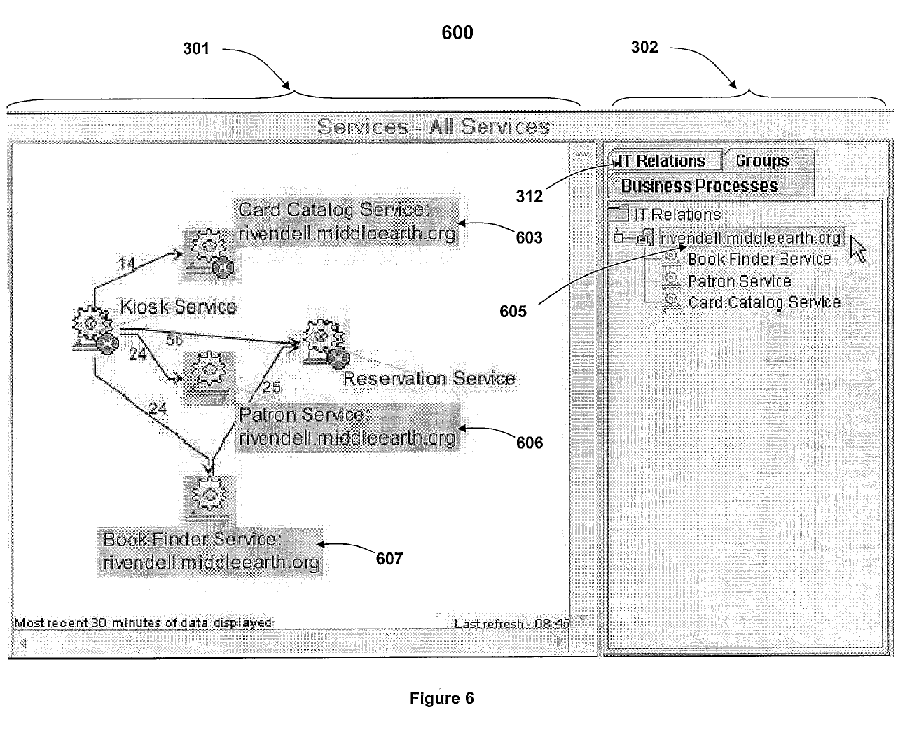

FIG. 6 is a screen display of an example topological graph with a secondary view, according to one embodiment of the invention. Display 600 comprises (primary view) graph 301, secondary view 302, and selected IT Relations Tab 312. Within display 600, Card Catalog Service 603, Patron Service 606 and Book Finder Service 607 are all highlighted in graph 301. Server “rivendell.middleearth.org” 605 is highlighted in secondary view 302.

By selecting another tab in secondary view 302 of graph 600, the user may explore a different secondary relationship in topological graph 301. “IT Relations”, shown in secondary view 302, is the current relationship type that is selected via “IT Relations” tab 312. Thus, in graph 600, RDH utility 110 highlights all the web services in the graph that are deployed on a particular server by selecting that server in the tree structure. Once again, selecting the (name of) server, for example, server “rivendell.middleearth.org” 605, in secondary view 302 causes the selection to be reflected in the graph's highlighting of the web services that are related to (i.e., deployed on) server “rivendell.middleearth.org” 605. Thus, server “rivendell.middleearth.org” 605 is defined as a secondary relationship. In particular, Card Catalog Service 603, Patron Service 606 and Book Finder Service 607 are all highlighted in graph 301 as these services are all deployed on server “rivendell.middleearth.org” 605.

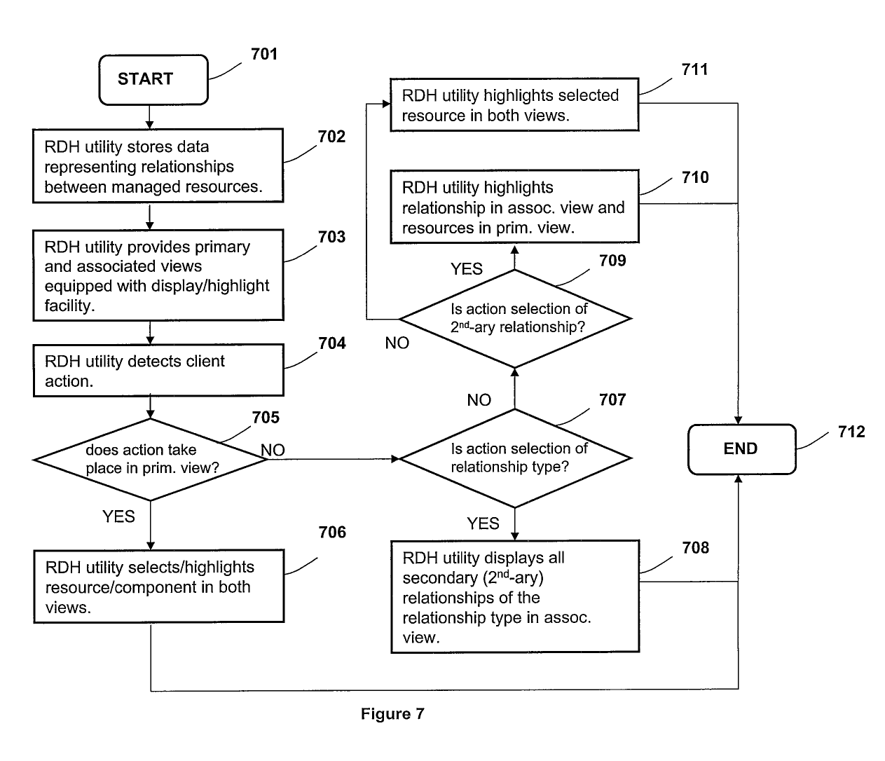

FIG. 7 is a flow chart illustrating a method by which the above processes of the illustrative embodiments are completed. Although the methods illustrated in FIG. 7 may be described with reference to components shown in FIGS. 1-6, it should be understood that this is merely for convenience and alternative components and/or configurations thereof can be employed when implementing the various methods. Key portions of the methods may be completed by RDH utility 110 executing within DPS 100 (FIG. 1) and controlling specific operations of/on DPS 100, and the methods are thus described from the perspective of either/both RDH utility 110 and DPS 100.

The process of FIG. 7 begins at initiator block 701 and proceeds to block 702, at which RDH utility 110 stores data which represents relationships between managed resources. At block 703, RDH utility 110 provides a primary view which displays a topological graph comprising iconic symbols and textual symbols representing the managed resources. Furthermore, resources which have a direct relationship may be connected by lines. Additionally, RDH utility 110 provides an associated (i.e., a secondary) view which displays a relationship structure, which may be a tree like structure, for example. In addition, the associated view is equipped with controls, such as selection tabs, for example, which may allow a client to select various relationship types in order to ultimately factor out a number of secondary relationships. A secondary relationship is a grouping within which a number of resources participate. Within the description of the illustrative embodiments, a resource/component may not be a secondary relationship and vice versa.

At block 704, RDH utility 110 detects a client/user action. RDH utility 110 determines, at block 705, whether the action is taking place within the primary view or the associated view. If RDH utility 110 determines that the client action occurs with within the primary view, RDH utility 110 responds to the action by highlighting the object of the action, i.e., a resource within the primary view. RDH utility 110 also highlights (any appearance of) the resource within the associated view, which demonstrates all the secondary relationships, within which, the resource participates. If, at block 705, RDH utility 110 determines that the client action does not occur within the primary view but, instead, takes place within the associated view, the process moves to decision block 707, at which, RDH utility 110 determines whether the action is a relationship-type selection. If RDH utility 110 determines that the action is a relationship-type selection, RDH utility 110 displays all secondary relationships of the selected relationship type in the relationship structure of the associated view, at block 708. RDH utility 110 also displays all resources/components of the secondary relationships in the relationship structure of the associated view. If RDH utility 110 determines that the action is not a relationship type selection, the process moves to decision block 709.

At block 709, RDH utility 110 determines whether the action is a secondary relationship selection. In one embodiment, by the elimination of all other options, the action may only be a resource selection if RDH utility 110 determines that the action is not the selection of a secondary relationship. If RDH utility 110 determines that the action is a secondary relationship selection, RDH utility 110 highlights the secondary relationship in the associated view, at block 710. RDH utility 110 also highlights the resources (which participate in the secondary relationship) in the topological graph of the primary view. RDH utility 110 also displays all resources/components of the secondary relationships in the relationship structure of the associated view. If RDH utility 110 determines that the action is not a secondary relationship selection but is a resource selection (by the process of elimination), the process moves to block 711, at which, RDH utility 110 highlights the resource in the topological graph of the primary view. RDH utility 110 also highlights the resource in the relationship structure of the associated view. The process ends at block 712.

In the flow charts above, one or more of the methods are embodied in a computer readable medium containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. By way of example, a non exclusive list of types of media, includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. In a computer system comprising a client executing a systems management software application, wherein said systems management software application displays component relationships via a graphical user interface, a method comprising:
storing data for a systems management software application, wherein said data represent a plurality of relationships between a plurality of resources;
providing a primary graphical view and one or more interactive associated views to indicate a set of relationships between the plurality of resources displayed in the graphical view;
when a relationship type is selected via the one or more associated views, indicating via a visual relationship structure in the associated view, a set of secondary relationships of the selected relationship type and the resources that participate directly in each one of the set of secondary relationships;
when a secondary relationship is selected within the associated view, generating a graphical response in the primary view and a response in the relationship structure of the associated view; and
when a resource is selected, creating a graphical response in the primary view and the associated view.

2. The method of claim 1, wherein said providing further comprises:
displaying a plurality of segmented screen views, wherein said views include the following:
(1) an interactive topological graph in a primary view area, wherein said graph displays a primary relationship between the data; and
(2) an interactive relationship visualization structure with a set of controls for a selection of a relationship type in an associated view area.

3. The method of claim 1, wherein said generating further comprises:
indicating the selected secondary relationship within the visual relationship structure in the associated view by highlighting the selected secondary relationship; and
highlighting, within the topological graph, each resource from among a set of resources which participate directly in the selected secondary relationship.

4. The method of claim 1, wherein said creating further comprises:
when a resource is selected via the associated view, highlighting the selected resource in the primary view and in the associated view;
when a resource is selected within the topological graph of the primary view, highlighting the following:
(1) the selected resource in the primary view; and
(2) any appearance of the resource in one or more secondary relationships, in the associated view.

5. A data processing system comprising:
a processor which executes a systems management software;
a memory system which stores the systems management software;
a network connection to one or a plurality of server computer systems;
a utility executing on the processor which provides the functions of:
storing data for a systems management application wherein said data represent relationships between a plurality of resources;
providing a primary graphical topological view and one or more interactive associated views to indicate a set of relationships between a plurality of resources displayed in the graphical view;
when a relationship type is selected via the associated view, indicating, in the associated view, a set of secondary relationships of the selected relationship type and the resources that participate directly in each one of the set of secondary relationships, via a visual relationship structure;
when a secondary relationship is selected within the associated view, generating a graphical response in the primary view and a response in the relationship structure of the associated view; and
when a resource is selected, creating a graphical response in the primary view and the associated view.

6. The data processing system of claim 5, wherein said functions for providing further comprises functions for:
displaying a plurality of segmented screen views, wherein said views include the following:
(1) an interactive topological graph in a primary view area, wherein said graph displays a primary relationship between the data; and
(2) an interactive relationship visualization structure with a set of controls for a selection of a relationship type in an associated view area.

7. The system of claim 5, wherein said functions for generating further comprises functions for:
indicating the selected secondary relationship within the visual relationship structure in the associated view by highlighting the selected secondary relationship; and
highlighting, within the topological graph, each resource from among a set of resources which participate directly in the selected secondary relationship.

8. The data processing system of claim 5, wherein said functions for creating further comprises functions for:
when a resource is selected via the associated view, highlighting the selected resource in the primary view and in the associated view;
when a resource is selected within the topological graph of the primary view, highlighting the following:
(1) the selected resource in the primary view; and
(2) any appearance of the resource in one or more secondary relationships, in the associated view.

9. A computer program product comprising:
a computer readable medium; and
program code on said computer readable medium, wherein said program code provides the functionality of:
storing data for a systems management application wherein said data represent relationships between a plurality of resources;
providing a primary graphical topological view and one or more interactive associated views to indicate a set of relationships between a plurality of resources displayed in the graphical view;
when a relationship type is selected via the associated view, indicating, in the associated view, a set of secondary relationships of the selected relationship type and the resources that participate directly in each one of the set of secondary relationships, via a visual relationship structure;
when a secondary relationship is selected within the associated view, generating a graphical response in the primary view and a response in the relationship structure of the associated view; and
when a resource is selected, creating a graphical response in the primary view and the associated view.

10. The computer program product of claim 9, wherein said code for providing further comprises code for:
displaying a plurality of segmented screen views, wherein said views include the following:
(1) an interactive topological graph in a primary view area, wherein said graph displays a primary relationship between the data; and
(2) an interactive relationship visualization structure with a set of controls for a selection of a relationship type in an associated view area.

11. The computer program product of claim 9, wherein said code for generating further comprises code for:
indicating the selected secondary relationship within the visual relationship structure in the associated view by highlighting the selected secondary relationship; and
highlighting, within the topological graph, each resource from among a set of resources which participate directly in the selected secondary relationship.

12. The computer program product of claim 9, further comprising code for:
when a resource is selected via the associated view, highlighting the selected resource in the primary view and in the associated view;
when a resource is selected within the topological graph of the primary view, highlighting the following:
(1) the selected resource in the primary view; and
(2) any appearance of the resource in one or more secondary relationships, in the associated view.
